(19) United States
(12) Patent Application Publication
(10) Pub. No.: US 2009/0023126 A1
(43) Pub. Date: Jan. 22, 2009

(54) Educational Apparatus Utilized in Teaching Children the Dangers of Drugs and Violence

(76) Inventor: Chiou-Wen S. Pan, Friendswood, TX (US)

Correspondence Address: KAREN A. REX, 950 Gemini, Suite 6, HOUSTON, TX, 77058, US

(21) Appl. No.: 12/173,870

(22) Filed: Jul. 16, 2008

Related U.S. Application Data
(60) Provisional application No. 60/961,254, filed on Jul. 19, 2007.

(51) Int. Cl. G09B 25/00

(52) U.S. Cl. 434/365

(57) ABSTRACT

The invention is an transparent apparatus shaped like a human doll, with an opening at its top and an open-end box as its base. The doll can be personalized with a photograph of the child playing with the doll. Several transparent slides to be inserted into or removed from the doll from its top are included, one with a stylized graph of a healthy person's internal organs; the rest, stylized graphs of partially damaged internal organs depicted as black areas as a result of drug use. The integration or disintegration of the image of the black areas of the slides depicts increasing or decreasing damage by drug use. Two non-transparent slides are included, one showing a slogan, the other healthy human organs not damaged by drug abuse. Slides and educational material containing visual illustrations of the death and destruction due to use of weaponry are also included.

### FIELD OF THE INVENTION

The present invention is in the field of providing instruction about the dangers of drugs and violence. The invention is in the form of a human doll including thin transparent panels placeable one on top of another and respectively picturing diverse portions of the body. Also included are panels depicting the results of violence occurring from the use of weaponry.

### BACKGROUND OF THE INVENTION

Previously, children have been discouraged from the use of drugs by programs such as the advertising campaign “Just Say No”, movies or printed materials such as posters and leaflets. However, none of these presentations are specifically tailored for younger children. The younger child needs to be able to identify personally and emotionally in order to achieve positive results in preventing drug abuse. Further, the daily news reports of increasing incidents of unprovoked attacks using guns and bombs by terrorists in many regions of the world, some fueled by the illicit drug trade, create an urgent need for additional educational material to show how this violence is harming people, especially children. Therefore, it is desirable in the field to have available an alternative teaching aid such as a doll to clearly present to a child the physical dangers presented by drug abuse and violence, whether derived from the production, sale and use of these illegal drugs or as a result of war.

An example of a teaching doll is disclosed in Harris, U.S. Pat. No. 6,080,034. Harris discloses a multi-cultural doll to simulate persons of various cultures. Another example of a teaching doll is U.S. Pat. No. 5,634,797 to Montgomery. The Montgomery device provides for a realistic simulation of sonographic images of actual heart defects.

Although each of the above teaching devices may be useful for their intended purposes, they do not educate children as to the dangers of drug abuse and violence by using a transparent doll to which the child may personally relate. The personalized doll allows for interchangeable slides graphically depicting the physical dangers of drug abuse by showing damage to internal organs and violence by showing pictures of the damage done to property and people by weaponry to be inserted and viewed. Further, a protest slide are included to help children to plead for safer surroundings so that they can build their futures safely.

### SUMMARY OF THE INVENTION

The present invention is an apparatus in the shape of a transparent human doll having an opening at its top and an open-end box as its base. Several transparent slides, one with a stylized graph of a healthy person's undamaged internal organs including red arteries and blue veins; the other transparent slides bearing stylized graphs symbolically showing partially damaged internal organs depicted as black areas as a result of drug use are to be inserted into or removed from the doll from its top. The integration or disintegration of the image of the black areas of the transparent slides depicts increasing or decreasing in damage by drug use and disuse. The picture of the transparencies inside the doll give children strong and direct message of health effects of drug abuse. The doll can be personalized with the photography of the child who plays with the doll. Two non-transparent slides are also included. One shows a slogan “No! Don't poison me”, and the other shows healthy human organs not damaged by drug abuse with vivid red arteries and blue veins on white board. For visual impact, brightly colored cardboard can be used for the “No! Don't poison me” slide.

The doll also includes interchangeable slides graphically depicting the physical dangers of violence incurred by the use of weapons, such as guns and bombs, by showing pictures of the damage done to property and people by these weapons. Further, a protest slides are included to help children to plead for safer surroundings so that they can build their future safely. A bag is adhered to the back of the doll to hold the slides when they are not in use. At the foot of the doll is an open-end box to keep the latest literature on drug abuse and violence.

### BRIEF DESCRIPTION OF THE DRAWINGS

FIG. 1 shows the front view of the personalized transparent apparatus in the shape of a human doll.

FIG. 2 shows the side view of the personalized transparent apparatus in the shape of human doll.

FIG. 3 shows a transparency containing a sketch of stylized internal organs and blood circulation systems with damages caused by the abuse of drugs. Black areas represent damages.

FIG. 4 shows a transparency depicting damages by a second drug.

FIG. 5 shows a transparency depicting damages by a third drug.

FIG. 6 shows the combined view of FIGS. 3,4 and 5 representing total damage by using a number of drugs or using a single drug in large quantity.

FIG. 7 shows a non-transparent slide with the slogan “No! Don't poison me!”.

FIG. 8 shows healthy internal organs of a child who does not use any drug or who used drugs but has withdrawn from said drugs. The child is a “NoDrug Kid®”.

FIG. 9 shows the combined view of FIGS. 3 and 5 transparencies from the front of the doll.

FIG. 10 shows the doll with FIG. 7 slide inside to demonstrate the child's determination not to use drugs after learning the dangers of drug abuse from playing with this “NoDrug Kid®” doll.

FIG. 11 shows removable labels with the names of some of the illegal drugs and one with excess alcohol; any of these labels can be placed on drug damage transparencies FIGS. 3, 4, 5, and/or 6.

FIG. 12 shows children's deaths caused by weapons of war.

FIG. 13 shows property destruction caused by war.

FIG. 14 shows a child in an unsafe environment caused by war.

FIG. 15 shows an example educational protest material slide.

### DESCRIPTION OF THE INVENTION

The present invention is an apparatus in the shape of a transparent human doll having an opening at its top and an open-end box as its base. Several transparent slides, one with a stylized graph of a healthy person's undamaged internal organs showing red arteries and clear blue veins; the other transparent slides bearing stylized graphs of symbolically partially damaged internal organs depicted as black areas as a result of drug use are to be inserted into or removed from the doll from its top. The integration or disintegration of the image of the black areas of the transparent slides depicts increasing or decreasing in damage by drug use and disuse. The picture of the transparencies inside the doll give children strong and direct message of health effects of drug abuse. The doll can be personalized with the photography of the kid who plays with the doll. Two non-transparent slides are also included. One shows a slogan “No! Don't poison me”, and the other shows healthy human organs not damaged by drug abuse with vivid red arteries and blue veins on white board. For visual impact, orange colored cardboard can be used for the “No! Don't poison me” slide.

The increasing incidents of attacks using guns and bombs by terrorists in many countries of the world create an urgent need for additional retrievable educational slides inside the doll to show how guns and bombs are harming people, especially children. Along with the pictures showing the damages done to property by these weapons, slides of injured and dead children are included. Further, a protest slide is included to help children to plead for safer surroundings so that they can build their future safely.

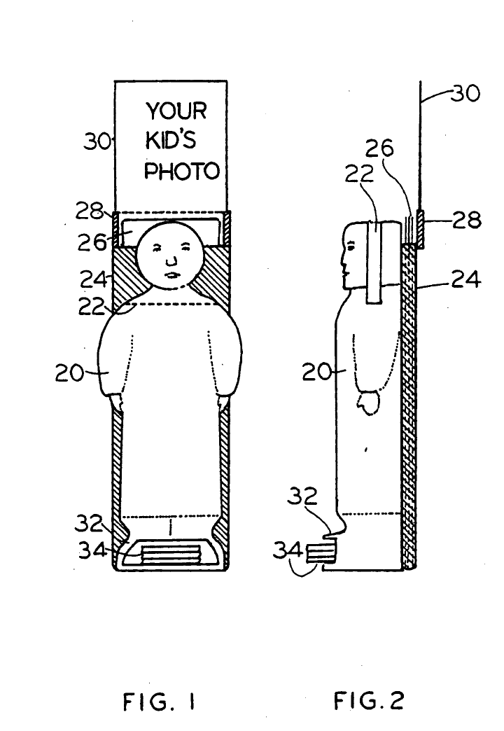

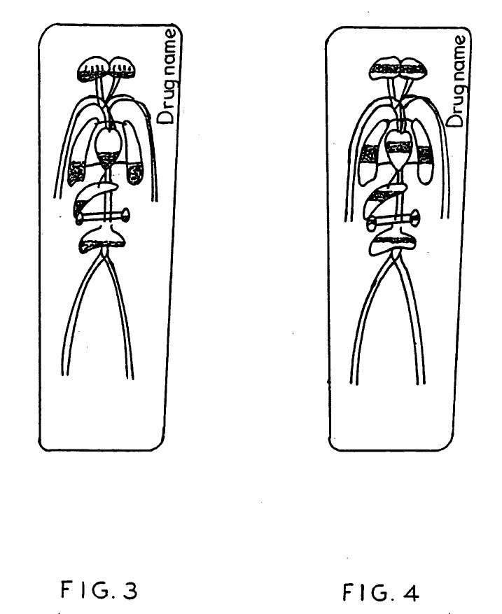

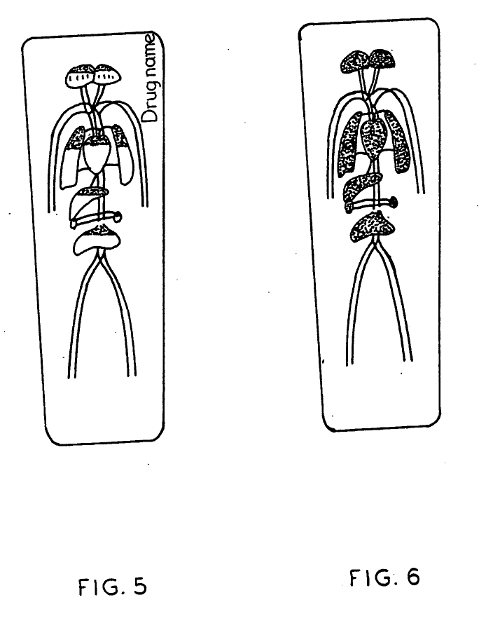

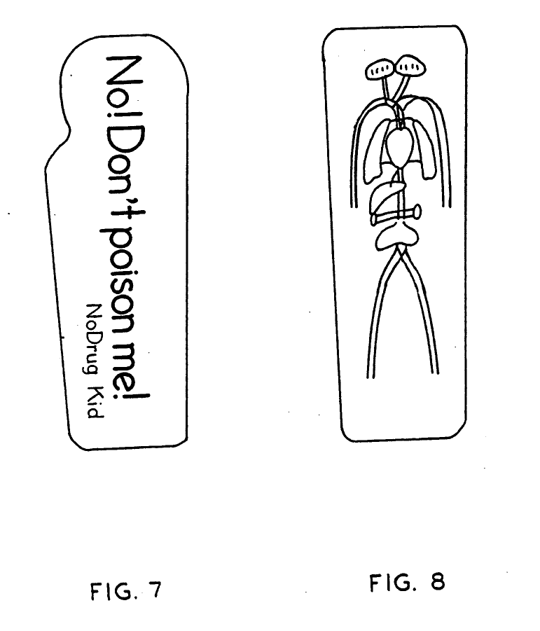

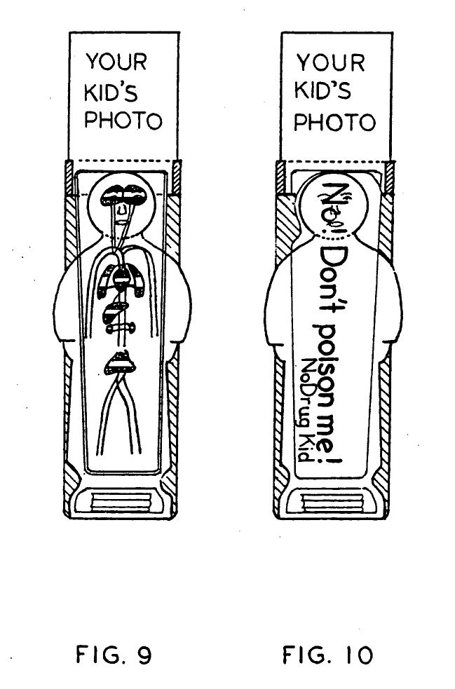

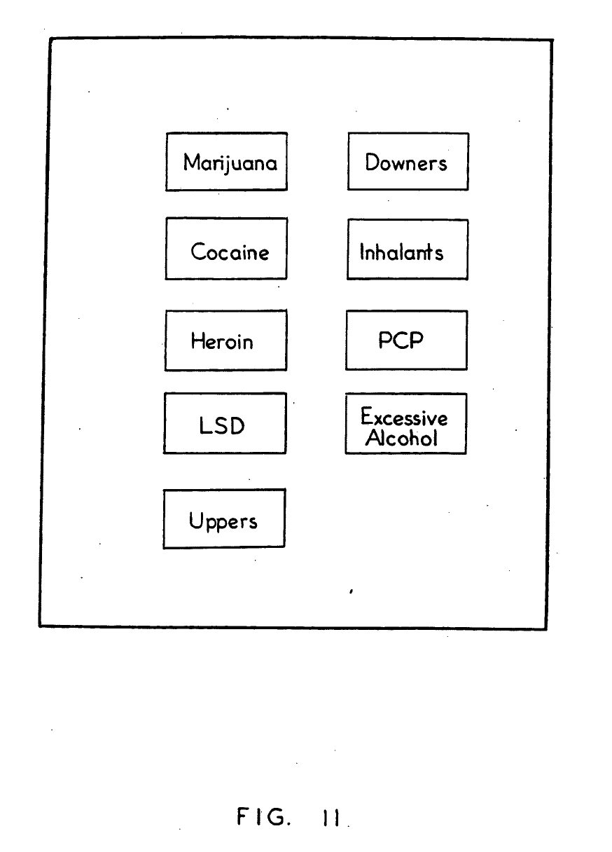

FIGS. 1 and 2 show respectively the front and the side view of a transparent apparatus in the shape of a human doll. The doll comprises a transparent three dimensional FIG. 20 and a slide storage bag 24. The doll has an opening 22 from the top of its head down to the broad side of its shoulders. The hole of the opening reaches down to the bottom of the figure. The transparent and non-transparent slides are kept in the storage bag 24. A slot at the top of the bag holds the doll player's photograph 28. An open-end box 32 at the bottom of the figure holds current drug abuse literature 34. FIGS. 3, 4, and 5 show transparencies with pictures of stylized human internal organs and blood circulation system. The arteries are in red color 40 and the veins in blue color 42. The black areas 44 depict the damages caused by drug abuse. Area 50 is location for the drug name label, which is shown in FIG. 11. FIGS. 3, 4, and 5 symbolically show damages done respectively by three different drugs. FIG. 6 shows the combined view of FIGS. 3,4, and 5 depicting total damage done by using a number of drugs or by using a single drug in large quantity. FIG. 7 shows the non-transparent slide with the resolution or determination of the child to refuse or quit drugs after viewing the damages or possible damages done to his/her body as shown by FIGS. 3, 4, 5 and/or 6. FIG. 8 shows the stylized healthy internal organs of a child who refuses to use any drugs or has withdrawn from using drugs. He/she is now a drug-free “NoDrug Kid®”. FIG. 9 shows the front view of the transparent doll looking through the combined image of transparencies of FIGS. 3 and 5 depicting a combined image of the damages done to internal organs. FIG. 10 shows the front view of the doll containing the slogan slide of FIG. 7.

Before playing with the doll, the child should preferably place a recent photograph of themself in slot 28 shown in FIGS. 1 and 2 in order to identify emotionally with the doll. The child transfers the slide of “NoDrug Kid®” from the storage bag 26 and inserts it into the body 20 of the figure through its opening 22. The front view of FIG. 1 is the view of a healthy person. Transfer of more transparencies from the storage bag 24 one by one into the body 20 of the figure until a combined view is formed in the likeness of FIG. 6 allows for a depiction of total damage of the internal organs and the complete deterioration of the child's health. The child who plays with the doll should then remove slides one by one and then will see the reduction of the damaged areas until the healthy internal organs of FIG. 8 appear again. The visual concept instills in the young mind the distinct message of the dangers of drug abuse. After that the child will transfer the slogan slide “No! Don't poison me!” into the body 20 of FIG. 1 to declare their determination to refuse all illegal drug use. The current literature on drug abuse 32 stored in the open-end box 34 at the base of the figure gives the child and parents more knowledge on drug abuse. This further reinforces the determination of the child to refuse illegal drug use.

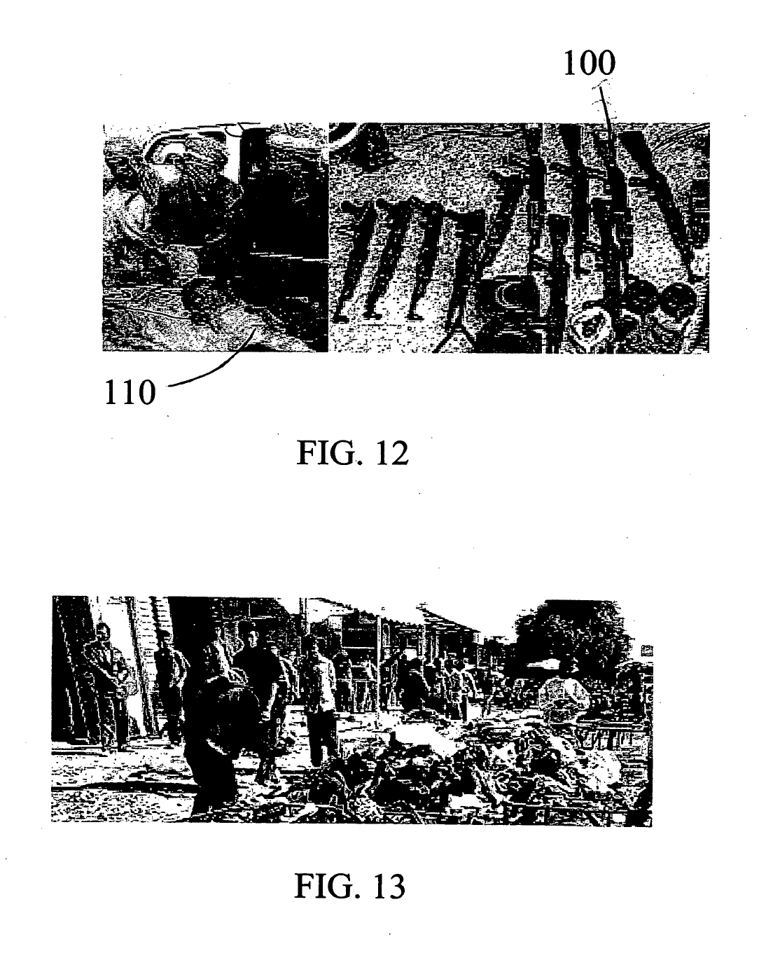

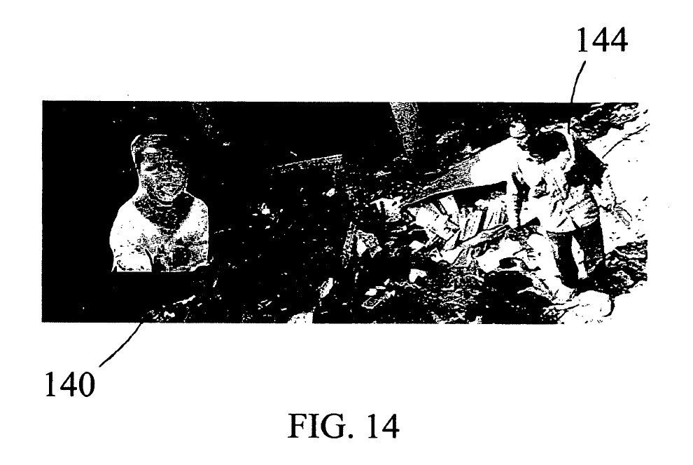

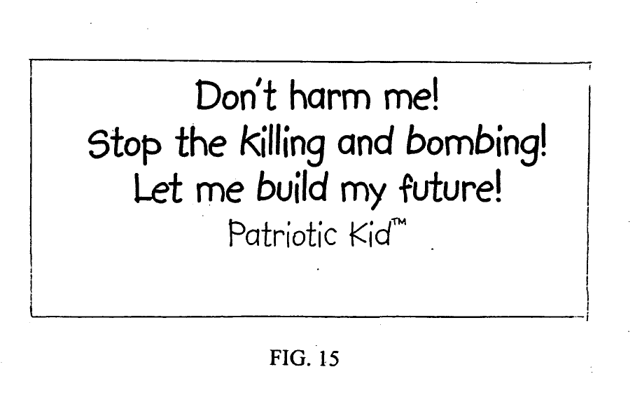

Currently, wars are raging intermittently or continually in many countries of the world. Some of these wars are caused by the illicit drug trade, some for territorial or other reasons, but all cause the death of innocent children. FIG. 12 and FIG. 13 show the destruction caused by weapons of war 100 and the resulting death of children 110. This causes parents 144 to not to be able to provide safe environments for their children 140, FIG. 14. Educational materials as shown in FIG. 15 must be made loosely available to those children in danger to enable them to protest so as to help alleviate their dangerous situations. Examples: “Don't harm me!”, “Stop the killing and bombing!” and “Let me build my future!”. These educational materials may also be presented as slogan slides such as shown in FIG. 7 with the resolution or determination of the child to stop the cycle of violence.

Other possible variations of embodiments can be envisioned within its scope. For example, the human doll may be changed into figures of animals or a mere clear container with attached heads and limbs. The contents of the slides, which can be added and removed readily in any number as characterized in the invention, may be changed into any drawing or print for some other educational, non-educational or recreational purpose. The transparent figure can be made into any size and of any transparent material.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. An apparatus for illustrating the effects of ingested harmful substances upon a human being comprising:
a. a generally transparent three dimensional figure of the human being;
b. means vertically disposed within the figure adapted uniquely to receive or retrieve one or more planar visualization slide means;
c. at least one transparent, planar, visualization slide means removably insert able within the figure, the slide means containing thereupon a visual illustration of one or more organs of the being with means therein showing deterioration of function due to ingestion of an identified harmful substance, said visualization slide means further having thereupon an identification means for the substance; and
d. such that whenever two or more such visualization slide means are inserted and superimposed within the figure a combined image appears illustrating an increase in deterioration of body function as a result of the ingested harmful substances identified on the identification means.

2. The apparatus as described in claim 1 above wherein the figure further comprises:
a. a head section, a torso section, and a leg section depicting a human figure;
b. an open container under the figure adapted for holding literature descriptive of drug abuse or similar matters;
c. a bag adhered to the back of the figure for storing the slide means when not in use;
d. a receiving slot attached to the top of the figure, adapted to receiving and holding the photograph of an individual; and
e. a waxy card containing removable labels each with a name of an illegal drug and one specifically for excessive alcohol, wherein the label can be put on the slide means for identification.

3. A simple apparatus for illustrating the effect of violence upon human beings comprising:
a. a generally transparent three dimensional figure of a human being.
b. means vertically disposed within said figure adapted uniquely to receive or retrieve one or more planar visualization slide means; and
c. at least one transparent, planar, visualization slide means removably insertable within the figure, the slide means containing thereupon a visual illustration of the death and destruction of human beings due to weaponry.

4. The apparatus as described in claim 3 above wherein the figure further comprises:
a. a head section, a torso section, and a leg section depicting a human figure;
b. an open container under the figure adapted for holding literature descriptive of drug abuse or similar matters;
c. a bag adhered to the back of the figure for storing the slide means when not in use; and
d. a receiving slot attached to the top of the figure, adapted to receiving and holding the photograph of an individual.
